(19) United States
(12) Patent Application Publication
(10) Pub. No.: US 2012/0230513 A1
(43) Pub. Date: Sep. 13, 2012

(54) SIGNAL PROCESSING DEVICE AND SIGNAL PROCESSING METHOD

(75) Inventor: Michiaki YONEDA, Kanagawa (JP)

(73) Assignee: Sony Corporation, Tokyo (JP)

(21) Appl. No.: 13/369,493

(22) Filed: Feb. 9, 2012

(30) Foreign Application Priority Data
Mar. 7, 2011 (JP) 2011-048595

(51) Int. Cl. H04R 3/00

(52) U.S. Cl. 381/96

(57) ABSTRACT

A signal processing device includes: a combining section combining a digital feedback signal associated with a movement of a diaphragm of a speaker unit and a digital audio signal; and a control section controlling the level of the digital feedback signal according to a difference between the level of the digital feedback signal and the level of the digital audio signal.

### FIELD

The present disclosure relates to a signal processing device and a signal processing method which can be used in, for example, an apparatus for reproducing audio signals.

### BACKGROUND

In the field of sound apparatus, a process called MFB (motional feedback) has been known. The MFB process involves the detection of an electric signal obtained from a movement of a diaphragm of a speaker. The detected electric signal is supplied as a negative feedback associated with an audio signal to control the movement of the diaphragm of the speaker unit. The negative MFB process suppresses unpleasant low frequency noise. Exemplary configurations for implementing MFB are disclosed in JP-A-08-223684 (Patent Document 1) and JP-A-08-223683 (Patent Document 2).

### SUMMARY

In the case of a system including an amplifier and a speaker unit which can be separated from each other, a user may connect the speaker unit to the system by him- or herself. When the speaker unit is connected, the connection may be made with polarities reversed as a result of an error of the user. That is, so-called reverse connection may be made. When a speaker unit is reverse-connected in a system executing a negative MFB process, the phase of a feedback signal is inverted, and a positive MFB process is consequently performed. A positive MFB process causes oscillation, and a problem therefore arises in that abnormal sounds can be output from the speaker unit. Such a problem is not only caused by reverse connection but also caused when a system is connected with a speaker in compliance with a different standard.

Thus, it is desirable to provide a signal processing device and a signal processing method which stops an MFB process, for example, when a speaker unit is reverse-connected in a system performing a negative MFB process.

An embodiment of the present disclosure is directed to a signal processing device including: a combining section combining a digital feedback signal associated with a movement of a diaphragm of a speaker unit and a digital audio signal; and a control section controlling the level of the digital feedback signal according to a difference between the level of the digital feedback signal and the level of the digital audio signal.

Another embodiment of the present disclosure is directed to a signal processing method of a signal processing device, including: combining a digital feedback signal associated with a movement of a diaphragm of a speaker unit and a digital audio signal; and controlling the level of the digital feedback signal according to a difference between the level of the digital feedback signal and the level of the digital audio signal.

According to at least one embodiment of the present disclosure, for example, when a speaker unit is reverse connected in a system performing a negative MFB process, the MFB process can be stopped.

### BRIEF DESCRIPTION OF THE DRAWINGS

FIG. 1 is a block diagram showing an exemplary configuration of a reproducing device;

FIGS. 2A and 2B are schematic illustration for explaining a gain margin and a phase margin, respectively;

FIG. 3 is a schematic graph showing exemplary open-loop characteristics of a speaker unit;

FIG. 4 is a flow chart showing an exemplary flow of processes performed by the reproducing device;

FIG. 5 is a block diagram showing an exemplary configuration of another reproducing device; and

FIG. 6 is a flow chart showing an exemplary flow of processes performed by another reproducing device;

### DETAILED DESCRIPTION

Embodiments of the present disclosure will now be described with reference to the drawings. The following items will be described in the order listed.

1. First Embodiment

2. Second Embodiment

3. Modifications

The embodiments and modifications described below are preferable exemplary modes of implementation of the present disclosure, and various technical specifications are shown as preferable examples. However, the present disclosure is not limited to the embodiments and modifications unless otherwise specified in the following description.

### 1. First Embodiment

### [Configuration of Reproducing Device]

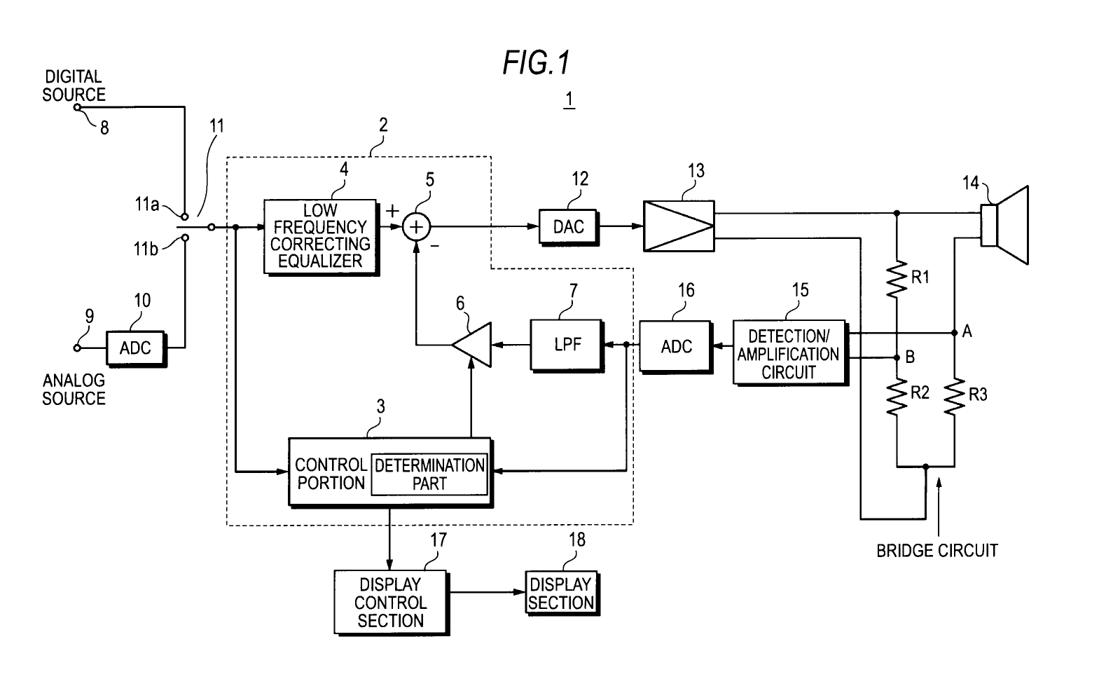

FIG. 1 shows an exemplary configuration of a reproducing device 1 according to an embodiment of the present disclosure. The reproducing device 1 has the function of reproducing audio signals which have been subjected to an MFB process. Obviously, the device is capable of reproducing audio signals which have not been subjected to an MFB process.

For example, the reproducing device 1 may be used in a television set, a personal computer, a game machine, or a mobile electronic apparatus. The reproducing device 1 includes a digital signal processing section 2. The digital signal processing section 2 is constituted by, for example, a DSP (digital signal processor). For example, in terms of the function, the digital signal processing section 2 is formed by a control portion 3, a low frequency correcting equalizer 4, a combining portion 5, a gain adjusting portion 6, and an LPF (low-pass filter) 7. Processes of the digital signal processing section 2 may be implemented by a program. As will be described later, functions of the control portion 3 include the function of determining a difference between the level of a digital audio signal and the level of a digital feedback signal and the function of performing a process according to the difference.

A digital audio signal and an analog audio signal are supplied to the reproducing device 1 as source signals. The digital audio signal is supplied to the reproducing device 1 through an input terminal 8. The digital audio signal is, for example, a signal of 48 kHz.

The analog audio signal is input to the reproducing device 1 through an input terminal 9. The supplied analog audio signal is converted into a digital audio signal by an ADC (analog-to-digital converter) 10. For example, a sampling frequency fs used in the process of the ADC 10 is 48 kHz.

A switch 11 operates depending on whether an audio signal supplied to the reproducing device 1 is a digital audio signal or analog audio signal. When a digital audio signal is supplied, the switch 11 is connected to a contact 11a. When an analog audio signal is supplied, the switch 11 is connected to a contact 11b. For example, the switch 11 is switched under control exercised by the control portion 3 or a CPU (central processing unit) which is not shown.

When either of digital audio signals or analog audio signals are only supplied to the reproducing device 1, the switch 11 is not required. Further, when audio signals are input over each channel of a multi-channel compatible sound source, a feature associated with each of the channels may be provided.

A digital audio signal input through the input terminal 8 or a digital audio signal supplied from the ADC 10 is selectively output from the switch 11. The digital audio signal output from the switch 11 is supplied to the control portion 3 and the low frequency correcting equalizer 4.

The low frequency correcting equalizer 4 corrects frequency characteristics of the digital audio signals thus supplied. For example, the low frequency correcting equalizer 4 is constituted by a second order IIR (infinite impulse response) filter. When the low frequency correcting equalizer 4 is constituted by a digital filter, the characteristics of the low frequency correcting equalizer 4 can be easily and quickly changed. Further, there is no need for paying attention to variations of characteristics of the elements constituting the filter.

Characteristics of the low frequency correcting equalizer 4 such as a correction level are determined by an equalizer coefficient. When the frequency correcting equalizer 4 is constituted by an IIR filter, the equalizer coefficient means a filter coefficient of the IIR filter. For example, the equalizer coefficient is set in the low frequency correcting equalizer 4 under control exercised by the control portion 3.

When a negative MFB process is performed without correcting frequency characteristics with the low frequency correcting equalizer 4, the speaker unit 14 will have such frequency characteristics that power in the neighborhood of a low resonance frequency f0 decreases. The low frequency correcting equalizer 4 corrects the frequency characteristics of a digital audio signal of interest in advance in order to prevent the power in the neighborhood of the low resonance frequency f0 from decreasing. That is, the low frequency correcting equalizer 4 corrects the frequency characteristics by increasing the power in the neighborhood of the low resonance frequency f0 which is attenuated by the MFB process in advance.

The correction carried out by the low frequency correcting equalizer 4 in advance allows sounds having desired frequency characteristics to be reproduced by the speaker unit 14. For example, flat frequency characteristics are obtained by the process of the low frequency correcting equalizer 4 as the desired frequency characteristics. The desired characteristics maybe arbitrarily set such as characteristics in which low frequencies are boosted or decreased to a certain level. A digital audio signal output from the low frequency correcting equalizer 4 is supplied to the combining portion 5.

The combining portion 5 inverts the phase of a digital feedback signal output from the gain adjusting portion 6. The combining portion 5 adds such a phase-inverted digital feedback signal and a digital audio signal supplied from the low frequency correcting equalizer 4. A digital audio signal obtained by the adding process is output from the combining portion 5.

The digital audio signal output from the combining portion 5 is supplied to a DAC (digital-to-analog converter) 12. The digital audio signal is converted into an analog audio signal by the DAC 12. The analog audio signal output from the DAC 12 is supplied to a power amplifier 13.

The power amplifier amplifies the analog audio signal at a predetermined amplification factor. The amplified analog audio signal is supplied to the speaker unit 14. The analog audio signal supplied causes the voice coil of the speaker unit 14 to vibrate. The vibration of the voice coil is transmitted to the diaphragm to vibrate the diaphragm. As a result of the vibration of the diaphragm, sounds according to the analog audio signal are reproduced by the speaker unit 14. For example, the speaker unit 14 is a speaker unit whose impedance undergoes no change such as a dynamic speaker.

There are several known methods which can be used for detecting the movement of the diaphragm of the speaker unit 14 during an MFB process. A method utilizing a bridge circuit is used in the present embodiment. According to the method, the speaker unit 14 is regarded as a resistor, and a bridge circuit formed by the speaker unit 14, and resistors R1, R2, and R3 is provided on a signal line between the power amplifier 13 and the speaker unit 14. For example, the resistance of the speaker unit 14 is a nominal impedance having a value of 4Ω, 8Ω, 16Ω, or 32Ω specified by the manufacture of the speaker unit. Let us call the connection point between the speaker unit 14 and the resistor R3, for example, “point A”, and let us call the connection point between the resistors R1 and R2, for example, “point B”.

A detection/amplification circuit 15 detects a potential difference between the points A and B. A potential difference between the points A and B is generated when the equilibrium condition of the bridge is disturbed as the speaker unit is driven. That is, the detection/amplification circuit 15 can detect a movement of the diaphragm of the speaker unit 14 by detecting a potential difference between the points A and B. A detection signal (potential difference) obtained by the bridge circuit represents a speed which is indicates the movement of the diaphragm of the speaker unit 14. Therefore, the MFB method shown in FIG. 1 is a type referred to as “speed feedback type.”

The amplifier 13 and the speaker unit 14 can be separated. A user may connect the amplifier 13 and the speaker unit 14. The system may be configured to allow a speaker unit different from the speaker unit 14 to be connected. When the speaker unit 14 is connected with the polarities reversed (reverse connection), a detection signal from the bridge circuit will have inverted polarities. As a result, the phase of a feedback signal based on the detection signal will be inverted.

For example, if a reverse connection is made in the speaker system when a negative MFB process is to be performed, a feedback signal having an inverted phase is further phase-inverted at the combining portion 5, and the resultant signal is added to a digital audio signal. Therefore, a positive MFB process consequently takes place. The positive MFB process causes oscillation, and abnormal sounds will be reproduced. The feedback process is stopped to prevent the reproduction of abnormal sounds. Details of such a process will be described later.

A detection signal obtained by the bridge circuit is supplied to the detection/amplification circuit 15 as a feedback signal. The feedback signal is supplied to an ADC after being amplified by the detection/amplification circuit 15. The ADC 16 converts the feedback signal supplied into a digital feedback signal and outputs the signal. The digital feedback signal output from the ADC 16 is supplied to the LPF 7 and the control portion 3 of the digital signal processing section 2.

For example, the LPF 7 is constituted by an IIR filter. The LPF 7 allows only signal components equal to or lower than a predetermined frequency to pass. The process of the LPF 7 eliminates frequency components unnecessary for the MFB process among the frequency components of the digital feedback signal. The digital feedback signal which has passed through the LPF 7 is supplied to the gain adjusting portion 6.

The gain adjusting portion 6 multiplies the digital feedback signal supplied from the LPF 7 by a predetermined gain coefficient. The level of the digital feedback signal is controlled by multiplying the digital feedback signal by the gain coefficient. For example, the gain coefficient can be changed under control exercised by the control portion 3.

When a normal MFB process is performed, a feedback amount used in the MFB process may be controlled by setting a gain coefficient appropriately. For example, when a great gain coefficient is set, the feedback mount increases, and the process can be performed such that a stronger negative feedback will be applied. Thus, a level-controlled digital audio signal is supplied to the combining portion 5. The phase-inverted digital feedback signal and the digital audio signal are added by the combining portion 5.

For example, the control portion 3 controls the level of a digital feedback signal by controlling the setting of the gain coefficient of the gain adjusting portion 6. A digital audio signal output from the switch 11 is supplied to the control portion 3. Further, a digital feedback signal output from the ADC 16 is supplied to the control portion 3.

For example, the control portion 3 converts the level of each of the digital audio signal and the digital feedback signal into an absolute value. The control portion 3 calculates a difference between the absolute levels of the digital audio signal and the digital feedback signal. It is determined whether the calculated difference is equal to or greater than a threshold Th or not.

When it is determined that the difference is equal to or greater than the threshold Th, the control portion 3 determines that the speaker unit 14 is reverse connected and oscillating. As described above, when the speaker unit 14 is reversely connected, the phase of a digital feedback signal is inverted, and a positive MFB process is therefore performed. A positive MFB process increases the level of a digital feedback signal. It is therefore possible to determine whether oscillation has occurred as a result of reverse connection by monitoring the level of a digital feedback signal relative to the level of a digital audio signal.

When it is determined that the difference is equal to or greater than the threshold Th, the speaker control portion 3 sets 0 or a value that is substantially 0 in the gain adjusting portion 6 as the gain coefficient. When the gain coefficient is set at 0 or a value that is substantially 0, no MFB process is performed on a digital audio signal. Therefore, sounds are reproduced based on the digital audio signal, and the reproduction of abnormal sounds attributable to oscillation can be prevented.

The threshold Th is appropriately set according to the level of a digital feedback signal relative to the level of a digital audio signal. The level of a digital feedback signal is determined by characteristics of the feedback system such as the impedance of the amplifier 13 and the speaker unit 14. For example, when the level of a digital feedback signal (e.g., 6 dB or 12 dB) is extraordinarily higher than the level of a digital audio signal, the gain coefficient is set at 0 or substantially 0.

When it is determined that the difference is smaller than the threshold Th, the determination process is continued. If the difference does not become equal to or greater than the threshold Th even when a predetermined period of time has passed since the beginning of the determination process, the determination process may be stopped based on an assumption that the speaker unit 14 has been properly connected.

A predetermined indication may be displayed when it is determined that the difference between the level of a digital audio signal and the level of a digital feedback signal is equal to or higher than the threshold Th. For example, when it is determined that the difference is equal to or greater than the threshold Th, the control portion 3 may notify a display control section 17 of the fact.

For example, the display control section 17 is constituted by a CPU and provided separately from the digital signal processing section 2. According to the notice from the control portion 3, the display control section 17 controls a display section 18 such that a predetermined indication is displayed. For example, the display control section 17 exercises control such that a warning saying “Please check speaker connection” is displayed on the display section 18. Obviously, the present disclosure is not limited to displaying an indication, and an alarm tone or the like may alternatively be reproduced.

For example, the display section 18 may be an LCD (liquid crystal display). The display section 18 may be configured as a touch panel to allow operational instructions to be given using the display section 18. Not only the display section 18 but also various other parts of the reproducing device 1 may be controlled by the display control section 17.

### [Gain Margin/Phase Margin]

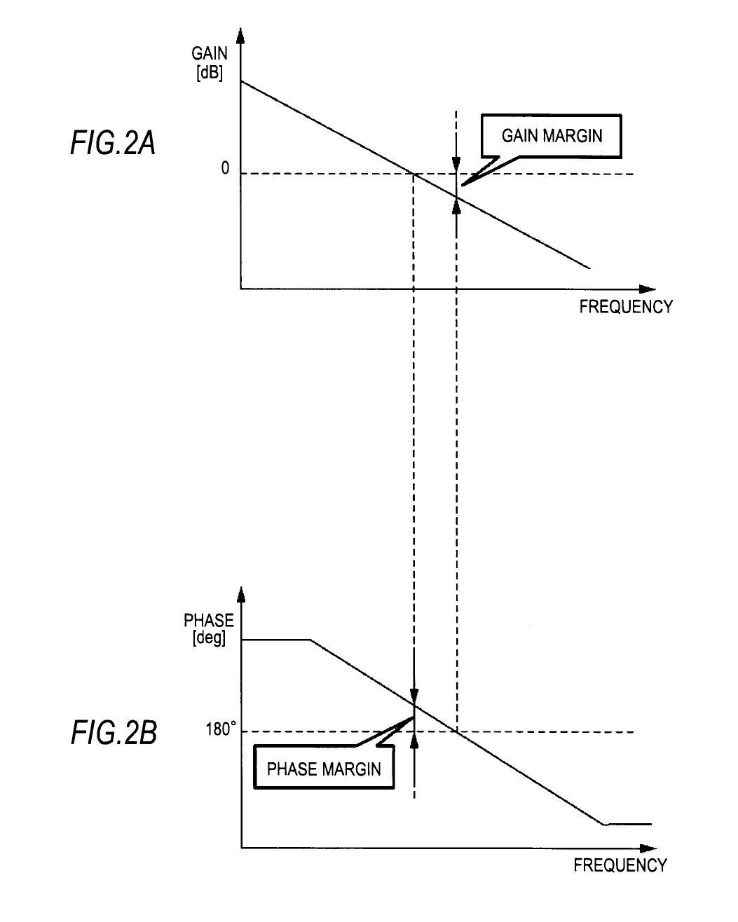

A gain margin and a phase margin will now be described. As shown in FIGS. 2A and 2B, a gain margin is a numerical value indicating the amount of a gain reduction that occurs at a phase angle of −180°. A phase margin is a numerical value indicating a margin from the phase angle of −180° when the gain is 0 dB. The system has higher stability against oscillation, the greater the gain margin and the phase margin. However, the gain margin and the phase margin are determined appropriately in consideration to the balance of the system such as the characteristics of the amplifier 13 and the speaker unit 14. For example, a gain margin of about 6 dB and a phase margin of about 30° or more are maintained as conditions to be satisfied to keep the feedback system stable.

### [Open Loop Characteristics]

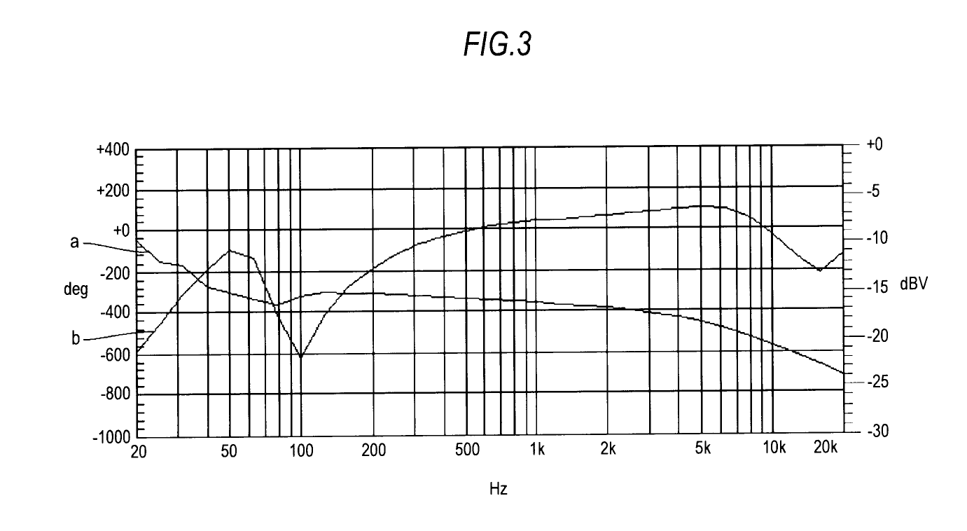

FIG. 3 shows open loop characteristics representing transitions in the gain and phase of the speaker unit 14 identified by open-loop measurement. Reference character a represents phase transitions, and reference character b represents gain transitions. It is assumed that the low resonance frequency f0 of the speaker unit 14 is 50 Hz by way of example. As shown in FIG. 3, the gain increases and the phase angle becomes 360° (0°) in the neighborhood of the low resonance frequency f0. A speed feedback MFB process can be stably performed by providing a gain margin and a phase margin as described above and eliminating unnecessary high frequency components with the LPF 7.

However, when the speaker unit 14 is reversely connected, the phase characteristics indicated by reference character a are inverted 180°. The gain exceeds 0 dB at a phase angle of −180°, and the condition for stable operations is no longer satisfied. Thus, there is a possibility of oscillation. In particular, a negative MFB process is different from a positive feedback process in that a great gain margin may be used to increase the amount of feedback. Therefore, when a positive feedback process takes place as a result of reverse connection, great abnormal sounds may be reproduced. According to the embodiment of the present disclosure, abnormal sounds can be stopped by stopping the feedback process as described above. Further, the reproduction of abnormal sounds can be prevented by setting the threshold Th appropriately. For example, a level lower than the level regarded as abnormal sounds may be set as the threshold Th to prevent reproduction of abnormal sounds attributable to oscillation in advance.

### [Process Flow]

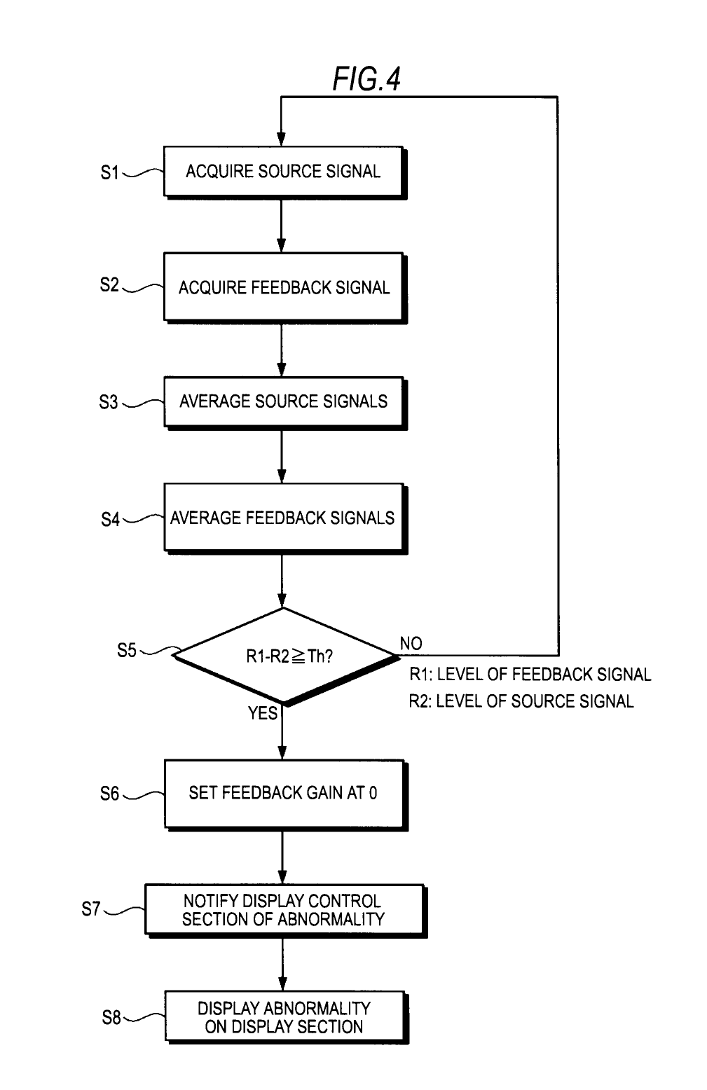

FIG. 4 is a flow chart showing an exemplary flow of processes performed by the reproducing device 1. At step S1, a process of acquiring a digital audio signal as a source signal is performed. For example, a digital audio signal output from the switch 11 is supplied to the control portion 3. The digital audio signal output from the switch 11 is corrected by the low frequency correcting equalizer 4, and the corrected signal is thereafter converted into an analog audio signal by the DAC 12. The analog audio signal is amplified by the amplifier 13 and thereafter reproduced from the speaker unit 14. The flow proceeds to step S2.

At step S2, a process of acquiring a feedback signal is performed. A detection signal is generated according to a movement of the diaphragm of the speaker unit 14. A feedback signal based on the detection signal is converted by the ADC 16 into a digital feedback signal. The digital feedback signal output from the ADC 16 is supplied to the control portion 3. Then, the flow proceeds to step S3.

At step S3, the control portion 3 averages levels of the digital audio signal which have been acquired during a certain period of time to obtain an average level R2 of the digital audio signal. Then, the flow proceeds to step S4. Processes at step S4 and subsequent steps maybe performed when the level R2 is equal to or lower than a predetermined level.

At step S4, the control portion 3 averages levels of the digital feedback signal which have been acquired during a certain period of time to obtain an average level R1 of the digital feedback signal. Then, the flow proceeds to step S5.

At step S5, it is determined by the determining function of the control portion 3 whether a difference between the levels R1 and R2 (R1−R2) is equal to or greater than the threshold Th or not. When it is determined that the difference (R1−R2) is smaller than the threshold Th, the flow returns to step S1. When it is determined that the difference (R1−R2) is equal to or greater than the threshold Th, the flow proceeds to step S6.

Since the difference (R1−R2) is equal to or greater than the threshold, the control portion 3 determines that the speaker unit 14 has been reverse connected and that a positive feedback process will therefore take place. At step S6, a process of setting the feedback gain at substantially 0 or at 0 is performed. For example, a gain coefficient 0 is set in the gain adjusting portion 6 by the control portion 3. When the gain coefficient 0 is set, the level of the digital feedback signal becomes 0, and the MFB process is disabled. Therefore, the speaker unit 14 reproduces an audio signal which has not been subjected to an MFB process. Then, the flow proceeds to step S7.

At step S7, the control portion 3 notifies the display control section 17 of the abnormality. Then, the flow proceeds to step S8. At step S8, a process of displaying an indication of the abnormality on the display section 18 is performed. According to the notice form the control portion 3, the process of displaying an indication of the abnormality on the display section 18 is performed by the display control section 17. For example, a message saying “please check speaker connection” may be displayed on the display portion 18.

An audio signal which has not been subjected to an MFB process is reproduced even after the feedback gain is set at 0 by the process at step S6. For this reason, an indication of the abnormality is displayed by the process at step S7, whereby a user can be reliably notified of the occurrence of abnormality.

It is not necessarily required to perform the processes of averaging signal levels at steps S3 and S4. For example, a difference between levels R1 and R2 may be calculated at predetermined time intervals.

As described above, even if a speaker unit is reverse connected in a system performing a negative MFB process, the reproduction of abnormal sounds attributable to oscillation can be prevented. Even when abnormal sounds attributable to oscillation is reproduced, the reproduction of abnormal sounds can be stopped because the feedback process can be stopped.

### 2. Second Embodiment

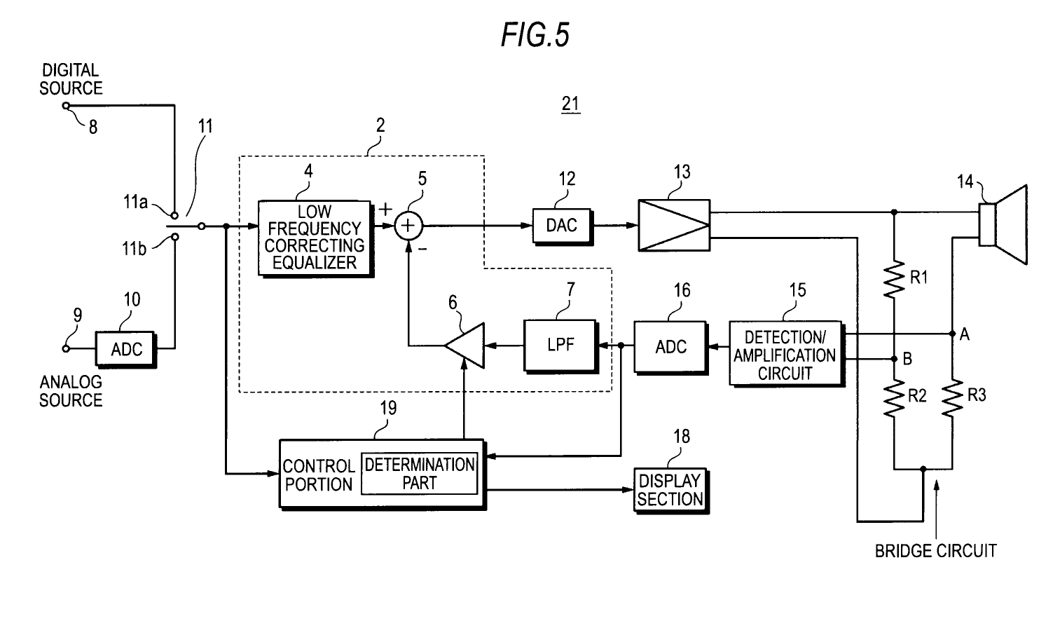

A second embodiment of the present disclosure will now be described. FIG. 5 shows an exemplary configuration of a reproducing device 21 according to the second embodiment of the present disclosure. A features which is identical between the reproducing device 21 and the above-described reproducing device 1 is indicated by the same reference numeral, and such a feature will be omitted in the following to avoid duplicated description.

The reproducing device 21 includes a control section 19 which has the function of the control portion 3 of the digital signal processing section 2 and the function of the display control section 17. The control section 19 is constituted by, for example, a CPU. A digital audio signal output from a switch 11 is supplied to the control section 19. Further, a digital feedback signal output from an ADC 16 is supplied to the control section 19.

The control section 19 controls the level of the digital feedback signal according to a difference between the levels of the digital audio signal and the digital feedback signal. For example, the control section 19 determines whether the difference between the levels of the digital audio signal and the digital feedback signal is equal to or greater than a threshold or not. When the difference is equal to or greater than the threshold, the control section 19 sets a gain coefficient of a gain adjusting portion 6 at 0 or substantially 0. The reproduction of abnormal sounds attributable to oscillation can be prevented or stopped under control exercised by the control section 19 in the same manner as in the above-described reproducing device 1. When the difference between the levels of the digital audio signal and the digital feedback signal is equal to or greater than the threshold, a predetermined indication may be displayed on a display section 18 under control exercised by the control section 19.

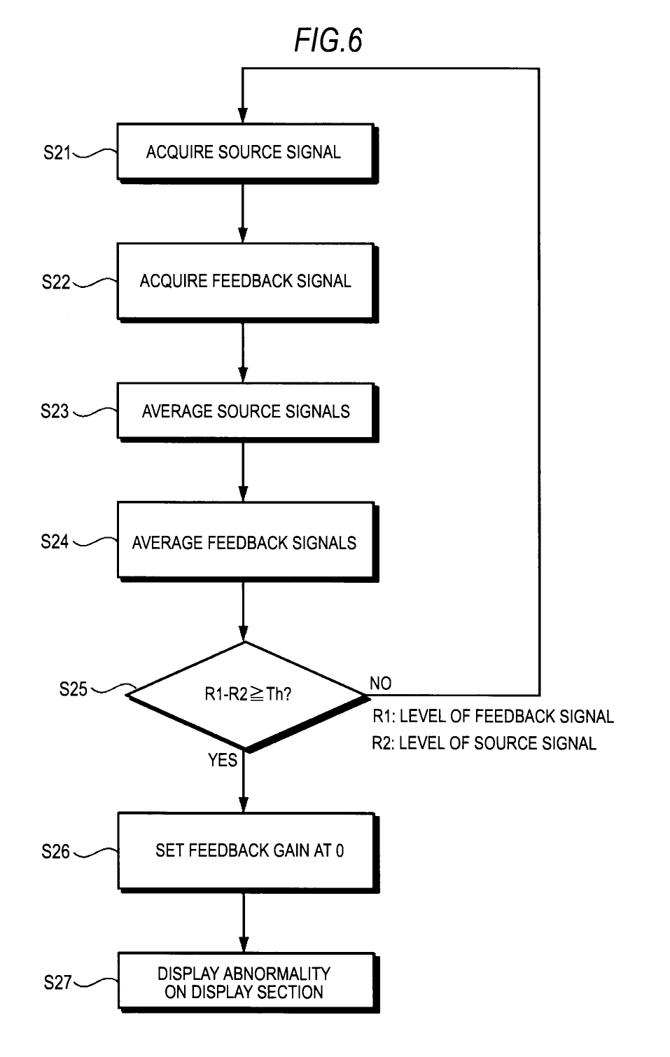

FIG. 6 is a flow chart showing an exemplary flow of processes performed by the reproducing device 21. At step S21, a process of acquiring a digital audio signal as a source signal is performed. For example, a digital audio signal output from the switch 11 is supplied to the control section 19. The digital audio signal output from the switch 11 is corrected by a low frequency correcting equalizer 4, and the corrected signal is thereafter converted into an analog audio signal by a DAC 12. The analog audio signal is amplified by an amplifier 13 and thereafter reproduced from a speaker unit 14. The flow proceeds to step S22.

At step S22, a process of acquiring a feedback signal is performed. A detection signal is generated according to a movement of a diaphragm of a speaker unit 14. A feedback signal based on the detection signal is converted by the ADC 16 into a digital feedback signal. The digital feedback signal output from the ADC 16 is supplied to the control section 19. Then, the flow proceeds to step S23.

At step S23, the control section 19 averages levels of the digital audio signal which have been acquired during a certain period of time to calculate an average level R2 of the digital audio signal. Then, the flow proceeds to step S24.

At step S24, the control section 19 averages levels of the digital feedback signal which have been acquired during a certain period of time to calculate an average level R1 of the digital feedback signal. Then, the flow proceeds to step S25.

At step S25, it is determined by a determining function of the control section 19 whether a difference between the levels R1 and R2 (R1−R2) is equal to or greater than a threshold Th or not. When it is determined that the difference (R1−R2) is smaller than the threshold Th, the flow returns to step S21. When it is determined that the difference (R1−R2) is equal to or greater than the threshold Th, the flow proceeds to step S26.

Since the difference (R1−R2) is equal to or greater than the threshold, the control section 19 determines that the speaker unit 14 has been reverse connected and that a positive feedback process will therefore take place. At step S26, a process of setting a feedback gain at substantially 0 or at 0 is performed. For example, a gain coefficient 0 is set in a gain adjusting portion 6 by the control section 19. When the gain coefficient 0 is set, the level of the digital feedback signal becomes 0, and the MFB process is disabled. Therefore, the speaker unit 14 reproduces an audio signal which has not been subjected to an MFB process. Then, the flow proceeds to step S27.

At step S27, a process of displaying an indication of the abnormality on the display section 18 is performed. A message indicating the abnormality is displayed on the display section 18 under control exercised by the control section 19. For example, a message saying “please check speaker connection” may be displayed on the display portion 18.

It is not necessarily required to perform the processes of averaging signal levels at steps S23 and S24. For example, a difference between levels R1 and R2 may be calculated at predetermined time intervals.

As thus described, the function of the control portion 3 of the digital signal processing section 2 may be performed by the control section 19 which is provided separately from the digital signal processing section 2. Further, the control section 19 may have function of the display control section 18.

### 3. Modifications

While embodiments of the present disclosure have been specifically described above, it is obvious that various modifications may be made to the embodiments. Modifications of the embodiments will now be described.

The control by the control portion 3 may be exercised on levels in the neighborhood of a frequency at which a gain margin and a phase margin are lost. For example, the control portion 3 detects the level of a digital feedback signal in the neighborhood of a low resonance frequency of the speaker unit 14. Further, the control portion 3 detects the level of a digital audio signal near the low resonance frequency of the speaker unit 14. The control portion 3 may control the level of the digital feedback signal according to a difference between the level of the digital feedback signal in the neighborhood of the low resonance frequency of the speaker unit 14 and the level of the digital audio signal in the neighborhood of the low resonance frequency of the speaker unit 14. The control section 19 may be similarly modified.

In an oscillating state, levels of a digital feedback signal in the neighborhood of the low resonance frequency appear extremely frequently. Therefore, an accurate determination process can be performed by focusing on levels of a digital feedback signal in the neighborhood of the low resonance frequency of the speaker unit 14 and levels of a digital audio signal in the neighborhood of the low resonance frequency of the speaker unit 14.

As described above, the process performed by the control portion 3 and the control section 19 are digital processes. It is therefore easy for those to perform processes such as the process of averaging signal levels and the process of extracting levels of a digital feedback signal in the neighborhood of the low resonance frequency and levels of a digital audio signal in the neighborhood of the low resonance frequency. Further, such processes can be quickly performed.

In the above-described embodiments, a digital audio signal output from the low frequency correcting equalizer 4 may be supplied to the control portion 3. The control portion 3 can be made to recognize the content of correction made by the low frequency correcting equalizer 4 in advance, and the control portion 3 can restore the digital audio signal to the state before the low frequency correction. Similarly, a digital feedback signal output from the LPF 7 or the gain adjusting portion 6 may be supplied to the control portion 3. In order to avoid complicatedness of processes, a digital audio signal output from the switch 11 and a digital feedback signal output from the ADC 16 are preferably supplied to the control portion 3.

In the above-described reproducing device 1, a movement of the diaphragm of the speaker unit 14 is detected by the bridge circuit. Alternatively, a displacement of the diaphragm may be detected using a capacitance or laser displacement gauge instead of the bridge circuit. Further, a coil separate from the voice coil of the speaker unit 14 maybe provided as a speed detecting sensor, and a current may be detected using the coil.

The movement of the diaphragm may be detected using an acceleration sensor or a microphone. Further, the movement of the diaphragm of the speaker unit 14 may be detected using a digital sensor. In this case, the output of the digital sensor is supplied to the digital signal processing section 2 as it is.

The MFB process has been described as what is called speed feedback type MFB, but the present disclosure is not limited to such a process. For example, the process maybe acceleration feedback type MFB. In the case of acceleration feedback type MFB, for example, a differentiation process portion is provided between the ADC 16 and the LPF 7. The differentiation process portion performs a differentiation process on a detection signal. The execution of a differentiation process is equivalent to measuring acceleration as a movement of the diaphragm. A signal which has been subjected to a differentiation process may be supplied to the LPF 7.

The reproducing device 1 may be configured to be compatible with speed feedback type MFB and acceleration feedback type MFB. Both of speed feedback type MFB and acceleration feedback type MFB may be simultaneously enabled. For example, a speed feedback type digital feedback signal and an acceleration feedback type digital feedback signal may be combined with a digital audio signal.

For example, the reproducing device 1 may be used in a headphone. When used in a headphone, the features of the reproducing device 1 may be grouped to be separately provided in the headphone and an audio player associated with the headphone. For example, the bridge circuit may be provided in the headphone, and other features such as the digital signal processing section 2, the DAC 12, the detection/amplification circuit 15, and the ADC 16 maybe provided in the audio player. Signals are transmitted and received between the headphone and the audio player on a wireless or wired communication basis.

The processes in the above-described embodiments of the present disclosure and the modifications of the embodiments may be implemented in the form of a method, a program, or a recording medium in which the program is recorded. Further, the processes in the above-described embodiments of the present disclosure and the modifications of the embodiments may be appropriately combined as long as no technical contradiction occurs. The flow of processes described above using the flow chart is not necessarily required to be followed in a time-sequential manner, and the processes may be performed in parallel. For example, the processes at steps S3 and S4 in FIG. 4 may be performed in parallel by the control portion 3. The present disclosure is applicable not only to situations in which a speaker unit is reverse connected but also to a wide range of situations in which an unwanted positive feedback process takes place to cause oscillation.

The present disclosure contains subject matter related to that disclosed in Japanese Priority Patent Application JP 2011-048595 filed in the Japan Patent Office on Mar. 7, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A signal processing device comprising:
a combining section combining a digital feedback signal associated with a movement of a diaphragm of a speaker unit and a digital audio signal; and
a control section controlling the level of the digital feedback signal according to a difference between the level of the digital feedback signal and the level of the digital audio signal.

2. The signal processing device according to claim 1, wherein the control section controls the level of the digital feedback signal according to a difference between the level of the digital feedback signal in the neighborhood of a low resonance frequency of the speaker unit and the level of the digital audio signal in the neighborhood of the low resonance frequency of the speaker unit.

3. The signal processing apparatus according to claim 1, wherein the control section controls the level of the digital feedback signal according to a difference between a level obtained by averaging levels that the digital feedback signal has during a predetermined period and a level obtained by averaging levels that the digital audio signal has during the predetermined period.

4. The signal processing device according to claim 1, wherein the control section controls a gain coefficient by which the digital feedback signal is to be multiplied such that the gain coefficient becomes substantially 0 when the difference between the level of the digital feedback signal and the level of the digital audio signal is equal to or greater than a threshold.

5. The signal processing device according to claim 4, wherein a predetermined indication is displayed when the difference between the level of the digital feedback signal and the level of the digital audio signal is equal to or greater than the threshold.

6. A signal processing method of a signal processing device, comprising:
combining a digital feedback signal associated with a movement of a diaphragm of a speaker unit and a digital audio signal; and
controlling the level of the digital feedback signal according to a difference between the level of the digital feedback signal and the level of the digital audio signal.
